(19) United States
(12) Patent Application Publication
(10) Pub. No.: US 2008/0011140 A1
(43) Pub. Date: Jan. 17, 2008

(54) CUTTER

(76) Inventor: Iee Gu Choi, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/776,336

(22) Filed: Jul. 11, 2007

(30) Foreign Application Priority Data
Jul. 13, 2006 (KR) 10-2006-0065720

(51) Int. Cl. B26D 1/14

(52) U.S. Cl. 83/491

(57) ABSTRACT

In a cutter, a transmission part includes: a fixing plate, which is mounted on one side of the machine frame, and on which a rotation shaft for the motor and a rotation shaft for the cutting blade are provided to project on the side portion of the machine frame; a reduction pulley, which is rotatably mounted on the fixing plate and has a two step structure; a first belt and a second belt for joining the driving pulley on the motor rotation shaft and the major diameter pulley of the reduction pulley and for joining the minor diameter pulley of the reduction pulley and the driven pulley on the rotation shaft of the cutting blade.

### TECHNICAL FIELD

The present invention relates to a cutter, especially to a cutter in which belts are used to transfer the force between a motor and rotary cutting blade so that the rotary force may be transferred more stably and the cutter may be maintained simply.

### BACKGROUND

In general, a cutter cuts hard metals with its cutting blade rotating at a high speed, and as shown in FIG. 1, the cutter contains a cutting part provided with a device for cutting a workpiece; a base part for securing the workpiece and supporting the cutting part; and a connection part for connecting the base part and the cutting part.

Specifically, the above cutting part comprises: a machine frame 1; a motor 4 mounted inside the machine frame 1 at one side and producing a driving force; a cutting blade 5 mounted on the machine frame 1 and being rotated with the driving force of the said motor 4 to cut the workpiece 11; a frame handle 6 formed on the machine frame 1 integrally and moving the machine frame 1 up and down; a switch 7 mounted on the frame handle 6 and turning on and shutting off the power supply of motor 4.

Furthermore, the base part consists of a base 2 and a bench clamp 8 mounted on the upper portion of the base 2 and securing the workpiece 11.

And, the connection part 3 is connected to the base 2 at one end thereof, and is rotatably connected to the cutting part through a hinge 9 at the other end. A spring 10 is mounted at one side of the hinge 9 and the machine frame rotates by the elasticity of the spring 10.

The operation state of the cutter with the above structure is described as follows:

Firstly, the workpiece to be processed is secured on the bench clamp 8, and the switch 7 mounted on the frame handle 6 is turned on (ON) to drive the motor 4 so that the cutting blade 5 rotates with the driving force of motor 4.

At this time, the frame handle 6 is pressed down, and the machine frame 1 rotates downward with the hinge 9 as pivot. In this way, the workpiece 11 is cut with the rotating cutting blade. However, in the above cutter, the coupling between the rotation shaft of cutting blade 5 and the motor 4 is obtained by the engagement of gears, thus due to the abrasion of the engaging parts occurred in high speed rotation, the rotary force may not be transferred enough evenly. Especially, when abrasion of the engaging parts of the cutting blade 5 and the motor 4 of the above cutter occurs, it cannot be repaired on site, but has to be repaired at a special maintenance depot. So the costs in labour and time are high.

Moreover, when changing the gears in the cutter, most of parts, such as the cutting part and the cutting blade, etc. must be removed one by one. So the time consumption in repairing is great. And, in the above cutter, since the engagement of the gears is used to transfer the force between the motor and the cutting blade, big noise is produced in operation.

### SUMMARY

The invention intend to solve one or more of the above problems, and an object of embodiments of the invention is to transfer the force between the motor and the rotary cutting blade through twostage belts so as to provide a cutter which transfers the rotary force stably, has low noise and is convenient to be maintained.

Another object of embodiments of the invention is to provide a tension regulating means for regulating the tension of the belt in the cutter, so as to regulate the tension of the belt.

To achieve one or more of the above objects, the cutter in an embodiments of the invention comprises an operating bench; a machine frame, which is rotatably fixed on the operating bench by one end with a switch provided on the other end; a motor, which is mounted at one end of the machine frame; a cutting part, which is positioned at one side of the machine frame and is provided with a cutting blade; and a transmission part, which transfers the power of motor to the cutting blade through a belt, the transmission part comprises: a fixing plate, which is mounted on one side portion of the machine frame, and a rotation shaft for the motor and a rotation shaft for the cutting blade which are provided to project on the side portion of the machine frame; a reduction pulley, which is rotatably mounted on the fixing plate and has a two step structure; a first belt and a second belt for joining the driving pulley on the motor rotation shaft and the major diameter pulley of the reduction pulley and for joining the minor diameter pulley of the reduction pulley and the driven pulley on the rotation shaft of the cutting blade.

Also, the cutter in a further embodiment of the invention comprises an operating bench; a machine frame, which is rotatably fixed on the operating bench by one end, with a switch provided on the other end; a motor, which is mounted at one end of the machine frame; a cutting part, which is positioned at one side of the machine frame and is provided with a cutting blade; and a transmission part, which transfers the power of motor to the cutting blade through a belt, the transmission part comprises: a fixing plate, which is mounted on one side portion of the machine frame, and a rotation shaft for the motor and a rotation shaft for the cutting blade which are provided to project on the side portion of the machine frame; a third belt for joining a driving pulley mounted on the rotation shaft for the motor and a driven pulley mounted on the rotation shaft for the cutting blade; and a guide pulley, which is rotatably mounted on the fixing plate and provides elastic supporting to the third belt. In an aspect, the transmission part is provided with a tension regulating means for regulating the tension of the belts, and in the tension regulating means, the reduction pulley is mounted movably in a cutting groove formed on the fixing plate and a screw bolt passes through a fixing sheet formed at the upside of the cutting groove of the fixing plate and makes a threaded connection with the axis of the reduction pulley, so that the reduction pulley rises and falls as the screw bolt rotates.

In a further aspect, the transmission part is provided with a tension regulating means for regulating the tension of the belt, and in the tension regulating means, the guide pulley is mounted movably in a cutting groove formed on the fixing plate and a screw bolt passes through a fixing sheet formed at the upside of the cutting groove of the fixing plate and makes a threaded connection with the axis of the guide pulley, so that the guide pulley rises and falls as the screw bolt rotates.

Moreover, on the fixing plate, the transmission part is provided removably with a casing for overlaying its circumference, and a plurality of through holes are formed on the outer surface of the casing.

Moreover, a voltage regulator for regulating voltage is provided on a power connecting part of the switch provided on the other end of the machine frame.

Moreover, a rotatable guide plate is mounted at an end portion of the guard board of the cutting part so that the spark produced in metal cutting of the cutting blade moves downwards along the inner surface of the guard board.

Moreover, the fixing plate forms a shape of arch bending upwards from two side portions on which the driving pulley and driven pulley are mounted to the center portion on which the reduction pulley is mounted.

In the cutter having the above structure, the driving force is transferred between the motor and the cutting blade through the transmission part comprising the first belt, the second belt and the reduction pulley. So the noise is significantly reduced, and when the cutting blade is overloaded, the motor may run idly, thereby significantly reducing the failure rate. And the cutter has the advantages of convenient maintenance and low repairing cost.

Moreover, after a two-stage deceleration of the first belt, the second belt and the reduction pulley, the rotary force of the motor is transferred to the cutting blade so that an optimum rotary speed required for cutting workpiece can be provided.

Moreover, by setting a tension regulating means for regulating the tension of the first belt and the second belt on the cutter, a more stable rotary force can be provided, and the replacing period of the belts is extended.

Moreover, by providing a casing for the transmission part, it can prevent the occurrence of accident, and also provide a better appearance.

### BRIEF DESCRIPTION OF THE DRAWINGS

FIG. 1 is a stereograph of a prior cutter;

FIG. 2 is a perspective view of the cutter according to an embodiment of the present invention;

FIG. 3 is an exploded view of the cutter of FIG. 2;

FIG. 4 is a side view of the cutter of FIG. 2;

FIG. 5 is a schematic drawing of the tension regulating means of an embodiment of the present invention;

FIG. 6 is a partial view showing the voltage regulator in an embodiment of the present invention;

FIG. 7 is a perspective view showing another example of the cutter of the present invention.

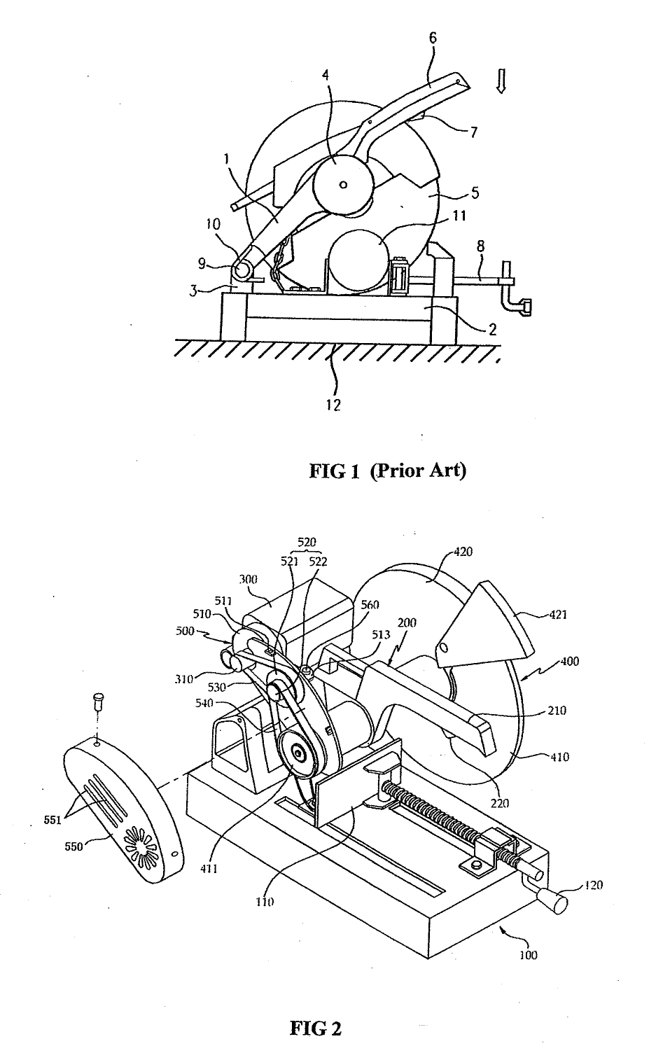

### DETAILED DESCRIPTION OF EMBODIMENTS

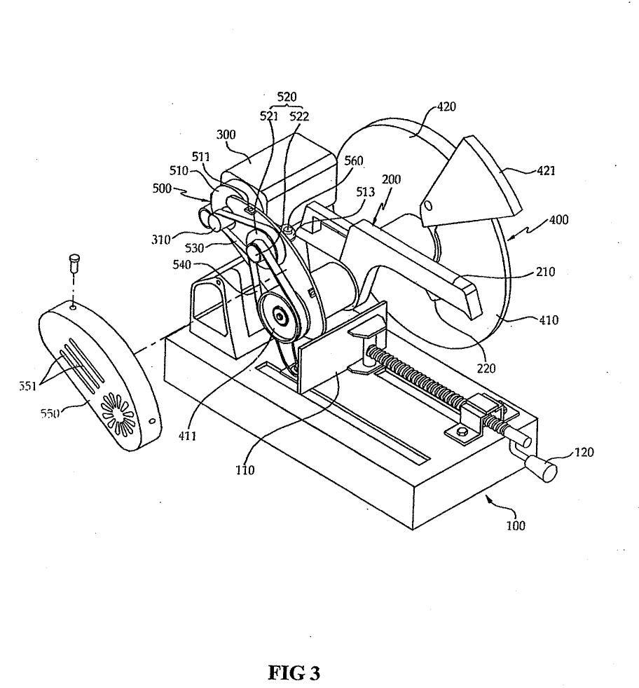

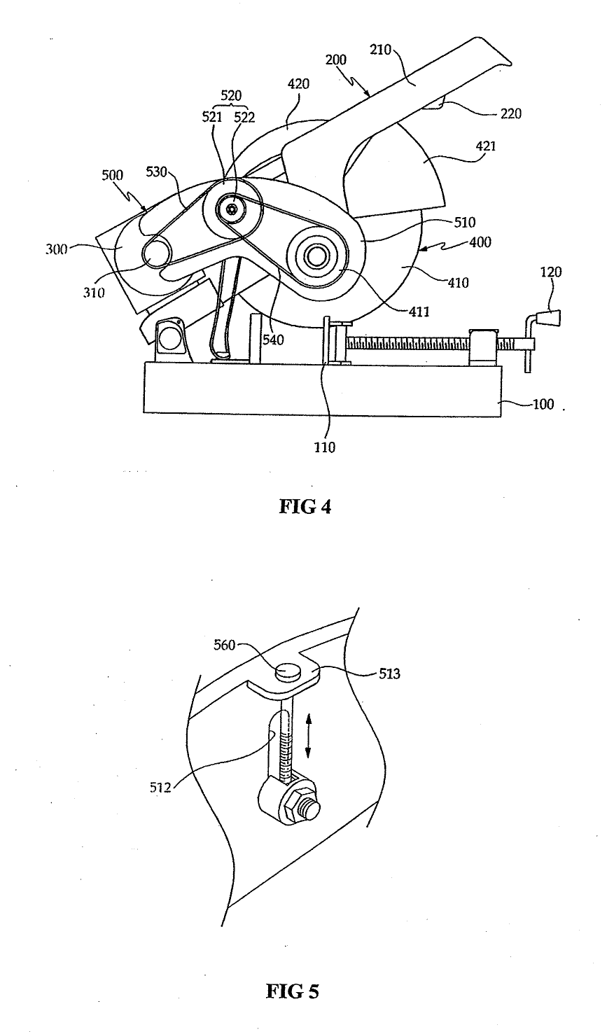

Hereinafter, an example of the invention will be described in detail with reference to FIG. 2 to FIG. 7.

As shown in FIG. 2 to FIG. 4, the cutter can cut hard metals with its cutting blade rotating at a high speed, the cutter comprises an operating bench 100 placed, e.g., on the ground; a machine frame 200 rotatably fixed on the operating bench 100 by one end, with a switch provided on the other end; a motor 300 mounted at one end of the machine frame 200; a cutting part 400, provided with a cutting blade positioned at one side of the machine frame 200; a transmission part 500 for joining the motor 300 and the cutting blade through belts.

The operating bench 100 is used to place workpieces. The machine frame 200 is hinge jointed on one end of the operating bench rotatably and a bench clamp 110 is mounted on it. The bench clamp 110 may move forwards and backwards through the rotation of the hand-operated crank 120 to secure and support the workpieces. A spring is provided on the hinge part to provide a restoring force for the machine frame 200 to return to the original position after being turned down.

The machine frame 200 was fixed on one end of the operating bench 100 rotatably through a hinge, and a handle 210 is provided at the other end of the machine frame. A switch 220 for turning on and shutting off the power supply is provided on the handle 210. The motor 300 and the cutting part 400 are provided at one side of the machine frame 200.

The motor 300 is provided at one side of the machine frame 200, and the switch 220 is used to control the rotation of the motor to supply a rotary force.

The cutting part 400 is used to cut workpieces, and it comprises a cutting blade 410 mounted on a rotation shaft at one side of the machine frame 200; a guard board 420 configured to envelop the circumference of the cutting blade 410. The cutting blade 410 employs a disc mill knife. The motor 300 and the cutting blade 410 are joined with the transmission part 500.

A rotatable guide plate 421 is mounted on the end portion of the guard board 420 so that the spark produced when the cutting blade 410 is cutting metal materials moves downwards along the inner surface of the guard board, thereby preventing the spark or dust from spraying towards the operator.

The transmission part 500 is joined with the motor 300 and the cutting blade 410 and transfers the driving force through belts.

Namely, the transmission part 500 comprises a fixing plate 510 mounted on one side portion of the machine frame 200; a reduction pulley 520 mounted rotatably on the fixing plate 510 and having a twostep structure; a first belt 530 and a second belt 540 for joining the motor 300 and the reduction pulley 520 and for joining the reduction pulley 520 and the cutting blade 410.

The fixing plate 510 is mounted by means of welding or bolts projecting on the side of machine frame 200 on which the rotation shaft of motor 300 and the rotation shaft of cutting blade 410. The reduction pulley 520 decelerates the rotation of the motor in transferring the driving force. It includes a major diameter pulley 521 and a minor diameter pulley 522 with different diameters and being formed integrally, and is mounted rotatably on the center portion of front surface of the fixing plate 510.

Namely, in the reduction pulley 520, a rotation shaft is provided in the center of the minor pulley 522 and the major pulley 521 formed, e.g., integrally therewith. After passing through the fixing plate 510, the rotation shaft is fastened by a fixing means, such as nuts and the like.

The first belt 530 and second belt 540 are used to join the driving pulley 310 on the rotation shaft of the motor 300 and the major diameter pulley 521 of the reduction pulley 520 and to join the minor diameter pulley 522 of the reduction pulley 520 and the driven pulley 411 mounted on the rotation shaft of the cutting blade 410. The diameters of the driving pulley 310 and the minor diameter pulley 522 are 20 to 40 mm, and the diameters of the driven pulley 411 and major diameter pulley 521 are 60 to 80 mm.

In such a way, in the transmission part 500, the driving pulley 310 of motor 300 rotates to cause the movement of the first belt 530, and the movement of the first belt 530 also makes the major diameter pulley 521 of the reduction pulley 520 rotate, with the rotation of the major diameter pulley 521, the minor diameter pulley 522 causes the movement of the second belt 540 which in turn makes the driven pulley 411 rotate, so that the cutting blade 410 has a rotating speed of 3800 to 4200 rpm.

A casing 550 for overlaying the circumference of the fixing plate 510 is provided removably on the fixing plate 510 of the transmission part 500.

The casing 550 is used to protect the transmission part 500 with one side opening, the interior periphery of the opening overlays the exterior periphery of the fixing plate 510, and the casing is fixed on a fixing sheet 511 at outside of the fixing plate 510 by bolt joints.

Moreover, a plurality of through holes 551 are formed on the outer surface of the casing 550 so that air may circulated through the through holes 511 to prevent overheating inside the casing. Moreover, as shown in FIG. 5, a tension regulating means for regulating the tension of the first belt 530 and the second belt 540 is mounted on the transmission part 500.

The construction of the tension regulating means is: the reduction pulley 520 is mounted movably in a cutting groove 512 formed on the fixing plate 510. A screw bolt 560 passes through a fixing sheet 513 formed at the upside of the cutting groove 512 of fixing plate 510, and forms a threaded connection with a fixing member, such as nuts and the like, connected on the axial portion of the guide pulley 520, so that the reduction pulley 520 may move up or down in the cutting groove 512 as rotation of the screw bolt 560 and the tension of the first belt 530 and the second belt 540 may be regulated.

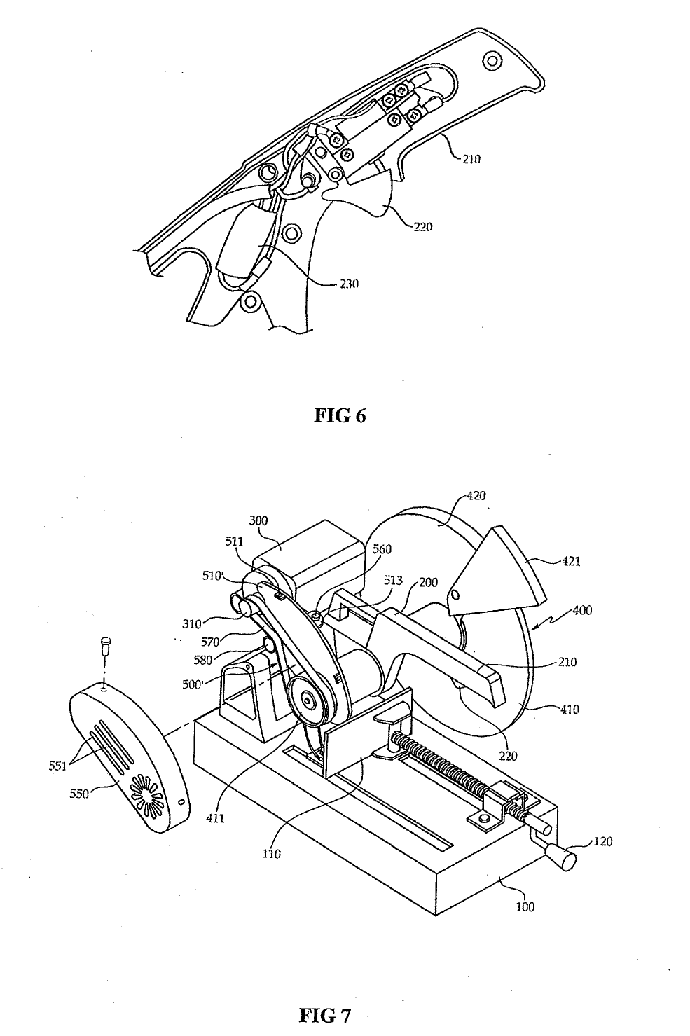

As shown in FIG. 6, a voltage regulator 230 having the functions of voltage regulating and electromagnetic wave shielding is mounted on the power connecting part of the switch 220 which is mounted on the handle 210 of the machine frame 200. A stable voltage is supplied to the motor 300 through the voltage regulator 230 to prevent overvoltage being applied to the motor 300, and the occurrence of electromagnetic wave can be significantly reduced.

Moreover, the fixing plate 510 bends upwards from two side portions on which the driving pulley and driven pulley are mounted to the center portion on which the reduction pulley 520 is mounted to form an arch in shape. In such a way, when the cutting blade 410 is used to cut a workpiece, the interference between the fixing plate 510 of the transmission part 500 and the workpiece can be avoided.

Hereinafter, the utilization method of the cutter having the above structure will be described. Firstly, after the cutter is connected to the power supply, a workpiece is placed on the bench clamp 110 of the operating bench 100. The hand-operated crank is rotated to move the bench clamp 110 so as to secure the workpiece.

Next, the handle 210 is grasped and the switch 220 is turned on. The external power supply is applied to the motor 300, and the driving pulley 310 mounted on the rotation shaft of the motor 300 rotates.

Then, the first belt moves and causes the rotation of the major diameter pulley 521 as well as the minor diameter pulley 522 of the reduction pulley 520. In turn, the second belt moves, so that the driven pulley 411 and the cutting blade 410 rotate.

That is, the rotating speed is reduced first by the first belt 530 joining the driving pulley 310 and the major diameter pulley 521 of the reduction pulley 520, and the rotating speed is reduced further by the second belt 522 joining the driven pulley 411 and the minor diameter pulley 522 of the reduction pulley 520. Afterwards, a rotary force is transferred to the cutting blade 410 so that the rotating speed of the cutting blade 410 is 3800 to 4200 rpm.

At this time, a stable voltage is supplied to the motor 300 through the voltage regulator 230 mounted on the power connecting part of the switch 220.

When the cutting blade 410 rotates, the handle of the machine frame 200 is turned downwards, and the workpiece is cut with the outer circumference of the cutting blade 410.

When the first belt 530 and the second belt 540 are loose after a long time's running of the cutter, the casing 550 is removed from the fixing plate 510 and the screw bolt 560 is rotated to make the reduction pulley 520 move up and down in the cutting groove 512 of the fixing plate 510, so that the first belt 530 and the second belt 540 associated with the major diameter pulley 521 and the minor diameter pulley 522 of the reduction pulley 520 are tightened, thereby achieving the object of regulating the tension.

When the first belt 530 and the second belt 540 are elongated to a predetermined length, the first belt 530 and the second belt 540 are removed from the driving pulley 310, the reduction pulley and the driven pulley 411, and a new first belt 530 and a new second belt 540 are applied to the driving pulley 310, the reduction pulley 520 and the driven pulley 411 respectively and then the tension is regulated.

After regulating the tension, the casing 550 is fixed to the fixing plate 510 in the same way as described above, as such to complete the maintenance of the cutter.

Hereinafter, another example of the invention will be described. The same reference numbers are used for representing the same members for which the detailed description is omitted.

FIG. 7 is a schematic view of another example of the cutter according to the invention.

As shown in FIG. 7, the transmission part 500′ of the above cutter comprises a fixing plate 510′ mounted on one side portion of the machine frame 200 on which the rotation shaft of the motor 300 and the rotation shaft of the cutting blade 410 are provided and projecting; a third belt 570 for joining the driving pulley 310 on the rotation shaft of the motor 300 and the driven pulley 411 on the rotation shaft of the cutting blade 410; a guide pulley 580 rotatably mounted on the fixing plate 510 and supporting elastically the third belt 570.

Accordingly, when the driving pulley 310 of the cutting blade rotates, the third belt 570 also moves, and the movement of the third belt 570 causes rotation of the driven pulley 411, so that the cutting blade 410 rotates.

Herein, the tension of the third belt 570 of the transmission part 500′ can be regulated by a tension regulating means. As shown in FIG. 5, the construction of the tension regulating means is: the guide pulley 580 is mounted movably in a cutting groove 512 formed on the fixing plate 510. A screw bolt 560 passes through a fixing sheet 513 formed at the upside of the cutting groove 512 of fixing plate 510, and forms a threaded connection with the axial portion of the guide pulley 580, so that the guide pulley 580 may move up or down in the cutting groove 512 as the screw bolt 560 rotates.

1. A cutter, which comprises
an operating bench;
a machine frame, which is rotatably fixed on the operating bench by one end, with a switch provided on the other end;
a motor, which is mounted at one end of the machine frame;
a cutting part, which is positioned at one side of the machine frame and is provided with a cutting blade; and
a transmission part, for transferring the power of the motor to the cutting blade,
wherein, the transmission part comprises: a fixing plate, which is mounted on one side portion of the machine frame, and a rotation shaft for the motor and a rotation shaft for the cutting blade which are provided to project on the side portion of the machine frame; a reduction pulley, which is rotatably mounted on the fixing plate and has a two step structure; a first belt and a second belt for joining the driving pulley on the motor rotation shaft and the major diameter pulley of the reduction pulley and for joining the minor diameter pulley of the reduction pulley and the driven pulley on the rotation shaft of the cutting blade.

2. A cutter, which comprises
an operating bench;
a machine frame, which is rotatably fixed on the operating bench by one end, with a switch provided on the other end;
a motor, which is mounted at one end of the machine frame;
a cutting part, which is positioned at one side of the machine frame and is provided with a cutting blade; and
a transmission part, for transferring the power of the motor to the cutting blade,
wherein, the transmission part comprises: a fixing plate, which is mounted on one side portion of the machine frame, and a rotation shaft for the motor and a rotation shaft for the cutting blade which are provided to project on the side portion of the machine frame; a third belt for joining a driving pulley mounted on the rotation shaft for the motor and a driven pulley mounted on the rotation shaft for the cutting blade; and a guide pulley, which is rotatably mounted on the fixing plate and provides elastic supporting to the third belt.

3. The cutter according to claim 1, wherein:
the transmission part is provided with a tension regulating unit for regulating the tension of the belts, and in the tension regulating unit, the reduction pulley is mounted movably in a cutting groove formed on the fixing plate, and a screw bolt passes through a fixing sheet formed at an upside of the cutting groove of the fixing plate and makes a threaded connection with the axis of the reduction pulley, so that the reduction pulley rises and falls as the screw bolt rotates.

4. The cutter according to claim 2, wherein:
the transmission part is provided with a tension regulating unit for regulating the tension of the belt, and in the tension regulating unit, the guide pulley is mounted movably in a cutting groove formed on the fixing plate, and a screw bolt passes through a fixing sheet formed at an upside of the cutting groove of the fixing plate and makes a threaded connection with the axis of the guide pulley, so that the guide pulley rises and falls as the screw bolt rotates.

5. The cutter according to claim 3, wherein:
on the fixing plate, the transmission part is provided removably with a casing for overlaying its circumference.

6. The cutter according to claim 5, wherein:
a plurality of through holes are formed on the outer surface of the casing.

7. The cutter according to claim 5, wherein:
a voltage regulator for regulating voltage is provided on a power connecting part of the switch provided on the other end of the machine frame.

8. The cutter according to claim 5, wherein:
a rotatable guide plate is mounted at an end portion of a guard board of the cutting part so that the spark produced in metal cutting of the cutting blade moves downwards along the inner surface of the guard board.

9. The cutter according to claim 1, wherein:
the fixing plate has a shape of arch that bends upwards from two side portions on which the driving pulley and driven pulley are mounted to the center portion on which the reduction pulley is mounted.

10. The cutter according to claim 4, wherein:
on the fixing plate, the transmission part is provided removably with a casing for overlaying its circumference.

11. The cutter according to claim 10, wherein:
a plurality of through holes are formed on the outer surface of the casing.

12. The cutter according to claim 10, wherein:
a voltage regulator for regulating voltage is provided on a power connecting part of the switch provided on the other end of the machine frame.

13. The cutter according to claim 10, wherein:
a rotatable guide plate is mounted at an end portion of a guard board of the cutting part so that the spark produced in metal cutting of the cutting blade moves downwards along the inner surface of the guard board.

14. The cutter according to claim 3, wherein:
the fixing plate has a shape of arch that bends upwards from two side portions on which the driving pulley and driven pulley are mounted to the center portion on which the reduction pulley is mounted.
